(19) United States
(12) Patent Application Publication
(10) Pub. No.: US 2002/0046422 A1
(43) Pub. Date: Apr. 25, 2002

(54) Portable sauna

(76) Inventor: Vladimir Perett, Toronto (CA)

Correspondence Address: DENNISON ASSOCIATES, SUITE 301, 133 RICHMOND STREET WEST, TORONTO, ON, M5H 2L7, CA

(21) Appl. No.: 09/933,138

(22) Filed: Aug. 21, 2001

(30) Foreign Application Priority Data
Aug. 21, 2000 (CA) 2,316,569

(51) Int. Cl. A61H 33/06

(52) U.S. Cl. 4/524

(57) ABSTRACT

Portable sauna-cabin for long-wave infrared dry-bath comprised of a floor-panel, a plurality of pillars holding a plurality of wall-panels and door, and a ceiling-panel mounted on the top of the pillars and wall-panels and strap all cabin together. Electric control boxes are preferably mounted on the front and side of the ceiling panel. The back wall-panels are provided with heat protected boxes with ceramic infrared emitters mounted inside for heating of the sauna unit. The floorpanel, pillars, front, side, back wall-panels and ceiling-panel are respectively connected into shape by means of groove and bolt-nut-joint. Everything may be conveniently detached when not in use.

### FIELD OF THE INVENTION

The present invention relates to a sauna unit and relates more particularly to a detachable or portable sauna unit or long wave infrared bath which can be assembled in any place desired and easily dissembled to reduce space when it is not in use.

### BACKGROUND OF THE INVENTION

Various movable types of sauna bathing units have been known. A major disadvantage of the conventional movable types of sauna bathing units is their fixed structure, which are not easily dissembled or collapsible, and therefore, require a large amount of space for storing the sauna-bathing unit even when it is not in use.

### SUMMARY OF THE INVENTION

The present invention has been accomplished to eliminate the aforesaid problem. It is therefore the main object of the present invention to provide a movable sauna unit, which can be conveniently disassembled to reduce space when it is not in use, and, which can be conveniently assembled in any home, cottage or even small apartment.

### BRIEF DESCRIPTION OF THE DRAWINGS

Preferred embodiments of the present invention are illustrated in the attached drawings in which:

FIG. 1 is a perspective view of a preferred embodiment of the sauna unit constructed according to the present invention;

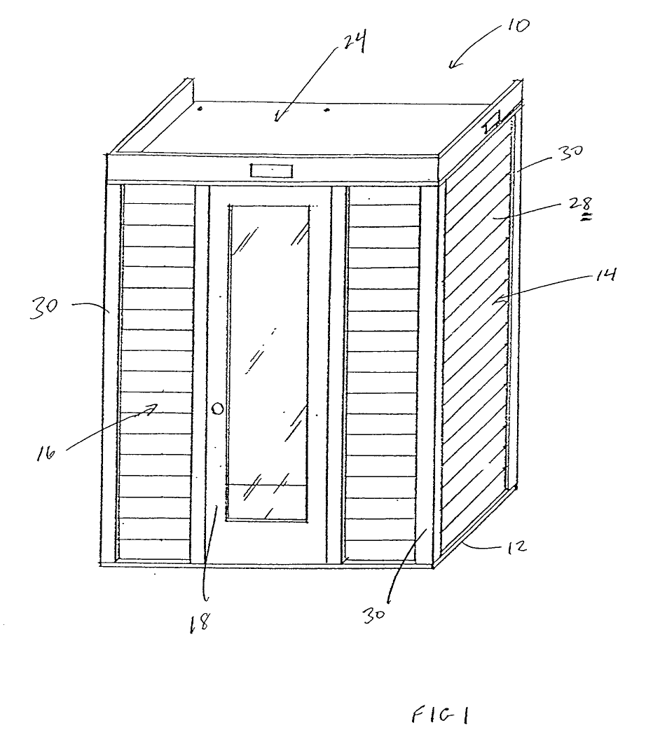

FIG. 2 is a dismantled perspective view of the major components of the sauna of FIG. 1;

FIG. 3 is a perspective view illustrating the connection of the components of the sauna of FIG. 1;

FIG. 4 is a top plan view of the top of the sauna of FIG. 1;

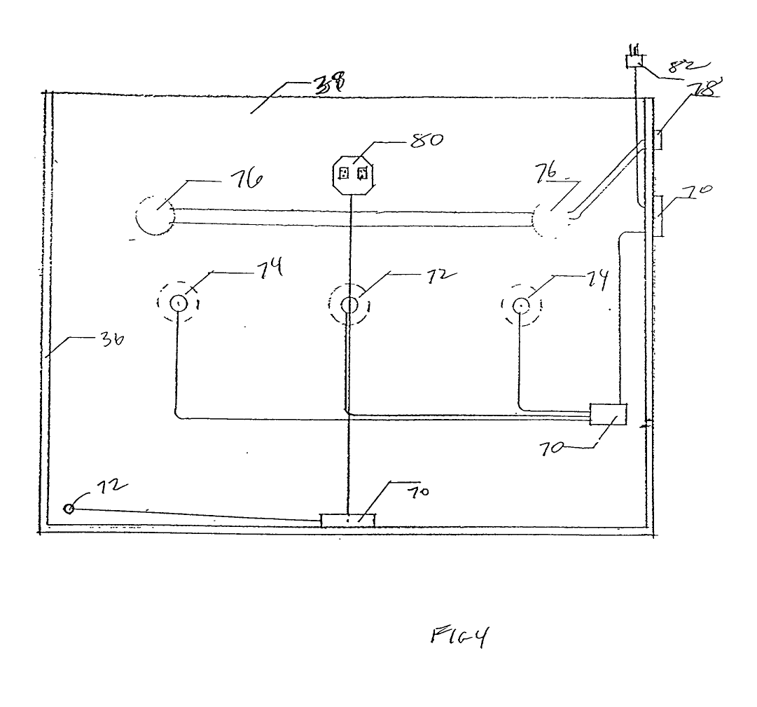

FIG. 5 is a side elevation view of the heating unit of the sauna of FIG. 1; and

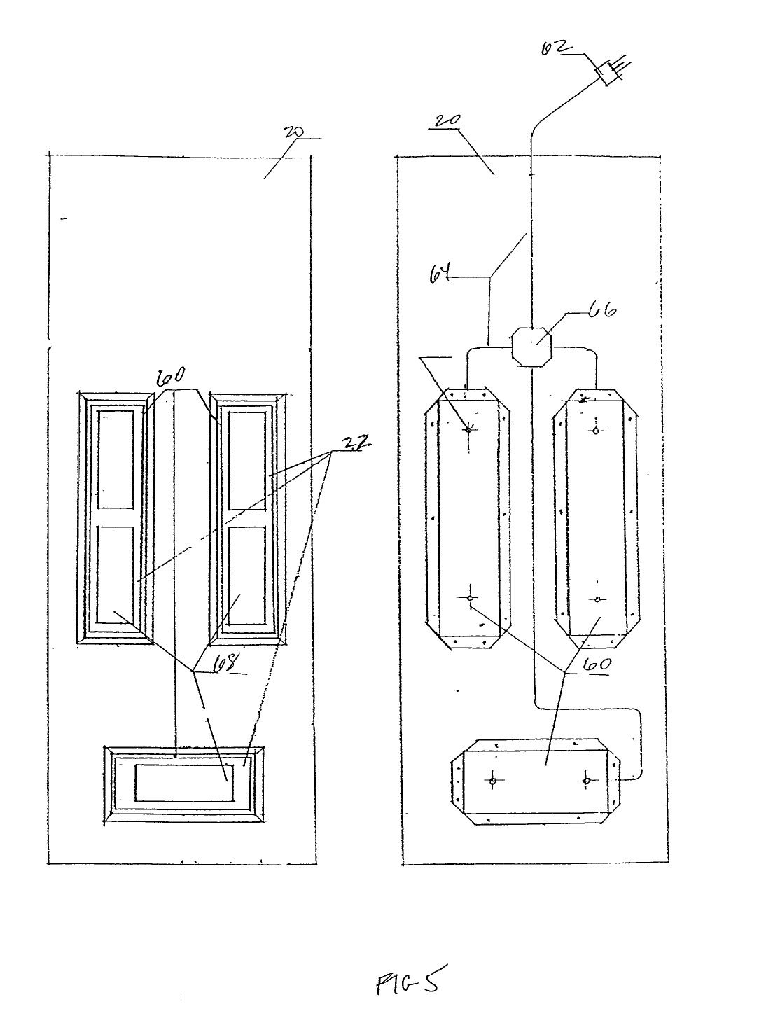

FIG. 6 is a perspective view of a bench for use in the sauna of FIG. 1.

### DETAILED DESCRIPTION OF THE PREFERRED EMBODIMENTS

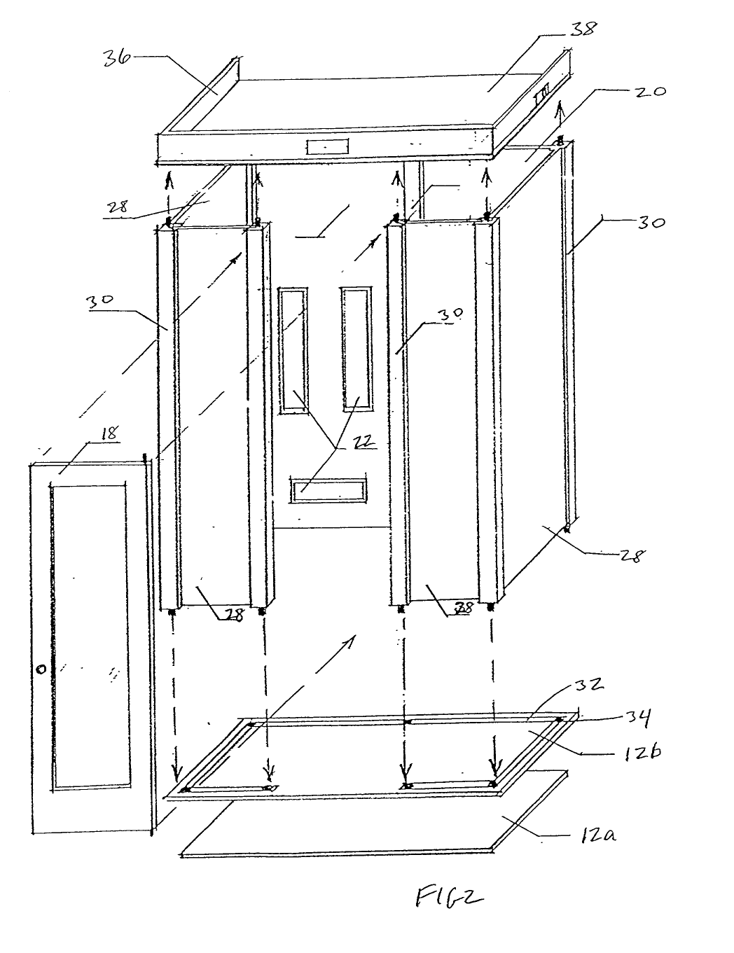

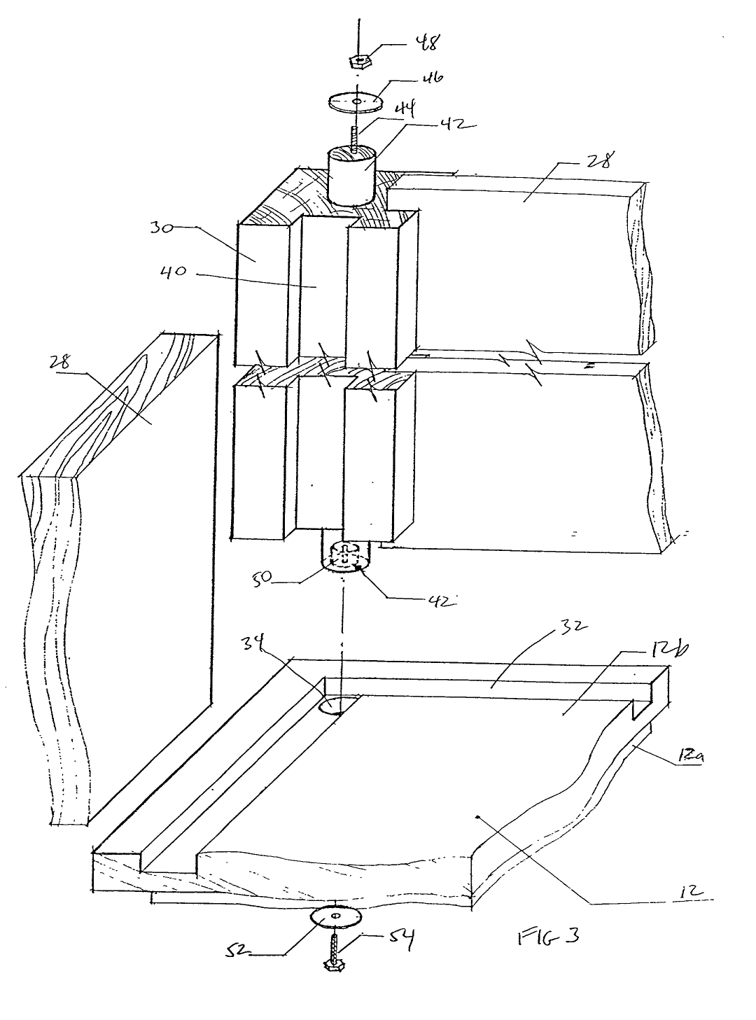

Referring to the attached drawings in detail, a sauna unit 10 as constructed in accordance with the present invention is preferably a rectangular box in shape having a base floor-panel 12 at the bottom, side walls 14, front wall 16 containing a door 18, a back wall 20 which contains a heating unit 22 as will be described below and a ceiling panel 24. As illustrated in detail in FIGS. 2 and 3, each of the walls is constructed of a wall panel 28 held by support pillars 30 extending between and connected to the base floor panel 12 and ceiling panel 24. In the preferred embodiment illustrated seven pillars 30 are utilized to hold six wall-panels 28 and door 18, although other configurations are possible. For example, different kind number of pillars and walls, wall panels with and without window or assembled from separate parts or boards may be utilized.

The floor-panel 12 is constructed as a rectangular plate or rectangular frame with a floor plate 12b having on the top surface adjacent the edges, elongated grooves 32, to hold the bottom edge of the wall-panels 28, and holes 34 placed in the proper location to insert the bottom end of the pillars 30. A bottom plate 12a may be attached to the bottom surface of the floor-panel 12b.

The ceiling-panel 24 is also constructed as a rectangular frame 36 with a ceiling plate 38 or rectangular finished plate without the frame and upwardly extending decorative panels on the front and side edges of the ceiling-panel 24. The bottom surface of the ceiling-panel is provided with elongated grooves adjacent the edges to hold the top edge of the wall-panels, and holes placed in the appropriate locations to insert the top end of the pillars. As well, on the bottom surface of the ceiling-panel 24 may be mounted suitable lighting for the sauna such as halogen minilights.

Each of the pillars 30 are provide with elongated grooves 40 extending the length thereof to hold the side edges of the wall panels 28. The pillars 30 for the front panel at the door edge are preferably provided with one elongated groove 40 to insert the side end of front wall-panels 28. Each of the corner pillars 30 are provided with two elongated grooves 40 on adjacent faces to hold the side edges of the wall panels 28. The pillar 30 for use in the back wall 22 is provided with two grooves 40 on opposite faces to hold the side edge of the back wall-panels 28. Alternatively, in the interest of ease of manufacturing, all of the pillars 30 may be constructed with a groove 40 on each of the four faces. In this situation, for aesthetic purposes, filler strips may be provided to fill in the exposed grooves 40.

The ends of all the pillars 30 are provided with a means of attachment of the pillar to the ceiling 24 and bottom panels 12. In the preferred embodiment, this means of attachment is wooden rods 42, which rest within the holes 34 in the ceiling 24 and bottom panels 12. The wooden rods 42 at the top of the pillars 30 are provided with a metal bolt 44 to which is attached a washer 46 and nut 48 or bolt to provide a tight connection with the ceiling-panel. The wooden rods 42 at the bottom of the pillars 30 are provided with a metal nut 50 or bolt inside to which is attached a washer 52 and bolt 54 to provide a tight connection with the floor-panel 12. Although other configuration of lock connections for the pillars 30 and floor panel 12 and ceiling panel 24 are possible.

To assemble the sauna 10 of the present invention, the bottom 12 is placed on the floor in a suitable location. One of the corner pillars 30 is attached to the bottom 12 and the side panel 28 slid into the groove 32 on the bottom 12 and the groove 40 on the pillar 30. The next pillar 30 is then attached to the side panel 28 and bottom 12. The remaining walls 14 and 16 are assembled in a similar manner. The door 18 is placed between two front pillars 30 at the middle. Once all of the walls 14 and 16 have been assembled on the bottom 12, the top 24 is placed oven the pillars 30 and wall panels 28 and the nuts 48 and bolts 54 tightened to complete the assembly. To disassemble the sauna 10, the above is repeated in reverse.

The heating unit (heating elements with reflectors) 22 and 68 is preferably installed in the back wall-panel 20. Each of the panels 20 is provided with three rectangular holes 60 to hold the ceramic heating elements (emitters) 68 To each hole is attached a metal box or metal sides and wooden bottom box with a heat resistant coating over the inside surface of the box. Preferably, the heat resistant coating is a ceramic paper cover over the inside of the box. The heating elements with reflectors 22 and 68 are then installed in the boxes. Preferably, two reflectors with double ceramic infrared emitters are installed in boxes 60 near the top of the back wall-panel 20 and one reflector with a single ceramic infrared emitter is installed in a box 60 near the bottom of the back panel 20. The heater elements with reflectors 22 and 68 are mounted inside the boxes by means of bolts with stand off insulators to space the heater elements away from the surface of the box and provide for air circulation around the heater elements with reflectors. The heater elements with reflectors 22 and 68 on each back-panel 20 are connected to a plug 62 on the top of the ceiling-panel through suitable wiring 64 and a junction box 66. The plug, which can plug 62 into a typical household receptacle.

Electric control boxes 70 are preferably mounted on a frame 36a front and side decorative board of the ceiling-panel 24. The electric control box 70 or electrical controller includes a connection to a temperature sensor 72 to provide a signal to an analog/digital converter and a motherboard, which comprises a time display and a temperature display. The converter provides signals to turn on and off the infrared emitters. The electric control box can be set to produce heat according to individual preference. Once the temperature inside the sauna-cabin exceeds the desired range, the power supply to the heaters will be automatically cut off to stop the operation. When temperature inside the sauna-cabin goes below the desired range, the power supply will automatically turn on the infrared emitters to continue the operation.

As noted above, the ceiling panel 38 of the sauna 10 may be provided with suitable lighting 74 connected to the control box 70. The sauna 10 may also be provided with speaker 76 connected to a radio on plug 78 adapted to connect to an external sound system. The ceiling panel 38 may be provided with a receptacle 80 to which the heater plugs 62 may be connected, all of the power circuits being connected to a plug 82 for connection to the household electric circuits.

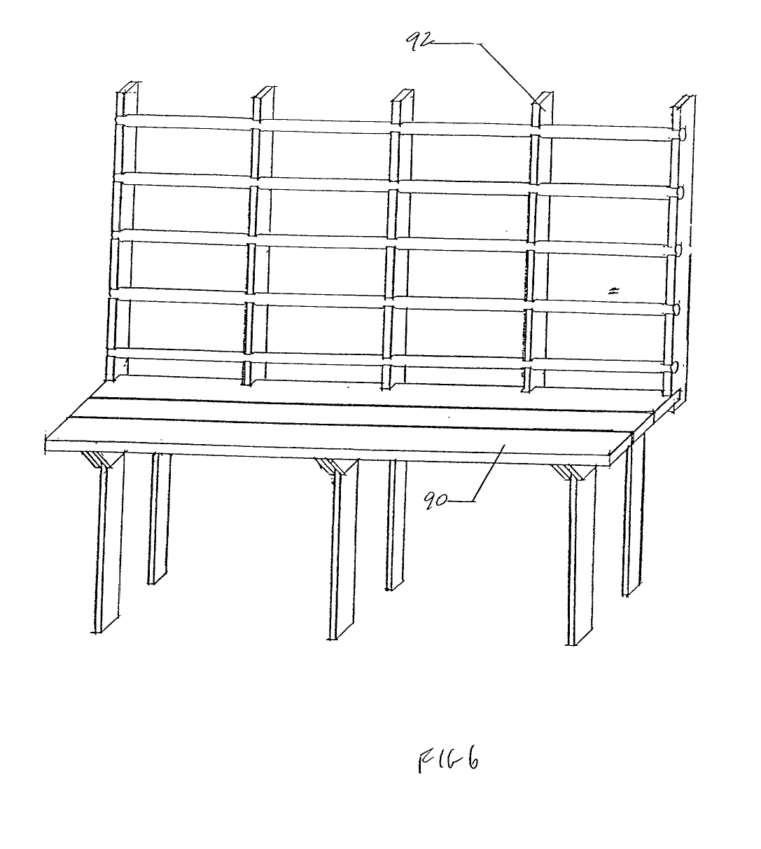

The sauna of the present invention is preferably provided with a removable bench 90 and back support 2 to rest against the back wall and provide protection against direct contact with the heaters. As shown in FIG. 6, the bench is a typical sauna bench of a height and width to accommodate the bather. The back support is preferably of a height to extend above the heater elements in the back wall and provide protection against direct contact with the heater element. The back support has a very open grid to allow for free air circulation to allow the heaters to heat the air in the sauna to the desired temperature.

The sauna of the present invention provides for an easy to assemble and disassemble unit convenient for any household. The sauna of the present invention provides for numerous benefits compared with traditional built in place saunas. Infrared heaters make the level of conveniences, technical parameters and effectiveness of the portable sauna, of the present invention incomparable with conventional or usual sauna:

| | | SAUNA OF THE PRESENT |
|---|---|---|
| POINTS | Usual SAUNA | INVENTION |
| Health mate | Some limitations | Much more effective as a |
| | because of hot air. | whole body therapy result |
| | Can harm respira- | because less air temperature |
| | tory organs. | and more time to use the |
| | | sauna, unharmed respiratory |
| | | organs. |
| Temperature for | 180 F.-220 F. | 100 F.-130 F. (38 C.-55 C.), |
| the same sweating | (83 C.-105 C.) | but if you want really hot |
| result | | air temperature - controller |
| | | allows you to increase |
| | | temperature up to 194 F. (90 C.) |
| Heat transmission | Electric stove: | Ceramic Infrared Ray 80% and |
| | Hot Air 80% and | only 20% Hot Air |
| | only 20% infrared | |
| | Ray | |
| Electric power | 6000 w and up- | 1500 w-14 amp (Like iron |
| (watt-amp) | min 20 amp | kettle) |
| Power line | Special power line | Plugs into 110 V household |
| | needed | power |
| Pre-heat time | 30-90 minutes | 5-10 minutes |
| Fresh air circula- | Not allowed | Allowed. Fresh air accessible |
| tion | | |
| Energy cost | Expensive | $2-$3/Month if use 1 hour |
| | | everyday |
| Length of time to | Short period in | Extensive |
| stay in | sauna | |
| Installation | Extensive time, may | 10 Minutes. Completely |
| | have to employ | knocks down into few easy to |
| | tradesman | re-assemble pieces |
| Appearance | Separate sauna room | High quality furniture with |
| | | indoor lights and built-in |
| | | sound system |
| Additional | Plumbing, special | Requires no plumbing, no |
| requirements | water proof wiring | special water proof wiring |
| | and ventilation are | and no ventilation |
| | required | |

Although various preferred embodiments of the present invention have been described herein in detail, it will be appreciated by those skilled in the art, that variations may be made thereto without departing from the spirit of the invention or the scope of the appended claims.

The Embodiments of the Invention in which an Exclusive Property or Privilege is claimed are defined as follows:

1. A portable sauna bathing unit for long wave infrared bath made in a rectangular shape and comprised of a base floor-panel at the bottom, a plurality pillars holding a plurality of wall-panels and door, a ceiling-panel mounted on the top end of all pillars and top end of all wall-panels.
